(19) United States
(12) Patent Application Publication
(10) Pub. No.: US 2022/0180705 A1
(43) Pub. Date: Jun. 9, 2022

(54) METHOD FOR A GAMING SYSTEM

(71) Applicant: Play'n Go Marks Ltd, Sliema (MT)

(72) Inventors: Martin ZETTERGREN, Sliema (MT); Charlotte MILIZIANO, Sliema (MT)

(73) Assignee: Play'n Go Marks Ltd, Sliema (MT)

(21) Appl. No.: 17/542,617

(22) Filed: Dec. 6, 2021

(30) Foreign Application Priority Data
Dec. 7, 2020 (SE) 2051426-1

(51) Int. Cl. G07F 17/32; G07F 17/34

(52) U.S. Cl. CPC G07F 17/3267; G07F 17/3262; G07F 17/34; G07F 17/3225

(57) ABSTRACT

The present disclosure relates to a computer implemented method performed by a gaming system. In particular, the present disclosure relates to a scheme for further improving an attraction power of a game provided in relation to the gaming system. The present disclosure also relates to a corresponding gaming system and a computer program product.

### CROSS-REFERENCE TO RELATED APPLICATIONS

This application claims priority to Swedish Patent Application No. 2051426-1, filed on Dec. 7, 2020. The disclosure of the above application is incorporated herein by reference in its entirety.

### TECHNICAL FIELD

The present disclosure relates to a computer implemented method performed by a gaming system. In particular, the present disclosure relates to a scheme for further improving an attraction power of a game provided in relation to the gaming system. The present disclosure also relates to a corresponding gaming system and to a computer program product.

### BACKGROUND

Games of chance are known and widely played for recreational purposes. The gaming industry has come to recognize that to sustain long term success it must be constantly innovative in introducing new games and new gaming concepts to the gaming public. One example of this innovating drive can be appreciated in the embrace of the Internet and online gaming by the gaming industry.

A common trend within the online gaming industry is to provide potentially new and current players with new means for attracting and ensuring that players remain at the online site, controlled by a gaming operator, providing the games.

An example of such a means is the introduction of dynamic game outcomes that change on every spin and or every cascade. The introduction of such dynamic game outcomes introduces further unexpected scenarios to a game which potentially allows a player to be further driven to participate in the game as well as further increase a payout to a player. Such dynamic game outcomes can be implemented by changing the size and or configuration of the slot grid. However, it has been found that such implementations may be visually chaotic.

Furthermore, the possible payouts must be closely controlled by a gaming operator to ensure that the payouts stay within desired boundaries. Thus, there is a general need to balance the attraction power of the game by means of these dynamic payouts, while at the same time ensuring that operator is in total control of the game.

### SUMMARY

According to an aspect of the present disclosure, the above is at least partly met by a computer implemented method performed by a gaming system, the gaming system comprising a server arranged in communication with an electronic user device using a network connection, the electronic user device comprising a display screen, wherein the method comprises the steps of forming, at the server, a table having a predefined dimension with columns and rows and comprising a plurality of cells, generating, at the server, a set of elements corresponding to the plurality of cells, each generated element being one of a plurality of predefined element types, populating, at the server, the plurality of cells with the set of elements, directing, using the server, the electronic user device to display the table at the display screen, assigning, at the server, a multiplication factor to at least one column or row of the table, identifying, at the server and by applying a predefined identification scheme, a number of cells of the table being populated with matching elements, determining, at the server, a gaming outcome based on the number and location of the matching elements within the table and the multiplication factor assigned to the at least one column or row of the table, and directing, using the server, the electronic user device to display the gaming outcome at the display screen.

According to the present disclosure, a novel approach to automatically determine a gaming outcome is defined, where e.g. a backend server has been specifically configured to control an electronic user device in such a manner that the electronic user device automatically displays the gaming outcome at a display screen comprised with the electronic user device. The electronic user device is furthermore generally adapted to at least in some stages of the determination of the gaming outcome display a graphical user interface (GUI) at the display screen, where e.g. a user (also referred to as a player) of the electronic user device is allowed to place a bet to be allowed to participate in a game executed at the server.

In accordance to the present disclosure, at least a portion of the gaming concept involves the player interacting with a table comprising a plurality of cells, where the cells are arranged in rows and columns and where each of the cells is populated with an element. Such elements may for example include different types of elements, for example including numbers and/or symbols of any kind and matching a desired implementation of the game to be played by the player.

The present disclosure makes use of a multiplication factor that has been assigned to at least one column or row of the table to further increase a randomness of the game being played by the player, thereby providing an additional layer of security to for the player, since the increased randomness possibly may ensure that the operator of the server (providing the game) has a lower ability to directly control a specific gaming outcome for the player. At the same time, the operator will be increasing the attraction to the game, possibly resulting in an increase number of players participating in the game provided by the server.

Thus, generally speaking, the present disclosure has the advantage of an improved attraction power to the game, thus potentially allowing for the player to remain playing the game for an increased duration as compared to previously known similar operational schemes. This could potentially be beneficial to both the player participating in the game and the gaming operator providing the game.

For ensuring that the matching is performed with a minimum amount of perceived delay in the progression of the game it is desirable to apply a computational efficient predefined matching scheme. Possible schemes that can be used in relation to the present disclosure include different forms of feature detection algorithms that today find usage within e.g. the computer vision field, such as for detecting and describing local features in images. In some embodiments of the present disclosure the predefined matching scheme may be selected to apply e.g. feature descriptors or feature vectors, where the plurality of predefined cluster formations are expressions of such feature descriptors or feature vectors. Other predefined matching schemes are also possible and within the scope of the present disclosure.

A determination of the gaming outcome will automatically be performed by the server based on the mentioned multiplication factor and a number and location of matching elements within the table. The concept of matching elements may be differently defined, but in one embodiment a set of matching elements are defined in case at least a predetermined number of matching cells (within the table) have been identified by the server. As an example, in one embodiment it is necessary that at least five matching elements are identified for the server to determine the gaming outcome. It may of course be possible to define the predetermined number of matching cells to be more of less than five matching elements, such as anywhere between 2-10 matching elements. The number of matching elements and their location is then influenced by the multiplication factor for determining the gaming outcome.

Possibly, but not necessarily, the gaming outcome is only determined by the server in case the matching elements are arranged in a “cluster”. Possibly, a cluster may be determined as “identified” if e.g. at least a predetermined number of cells comprising matching elements are located adjacently to each other. The predetermined number of cells may for example again be five, however this predefined number may also be lower or higher. The definition of “adjacently” may be dependent on the specific implementation of the present scheme. For example, adjacently may be defined as arranged on the same row of the table or in the same column of the table. It may however also be possible to allow other cluster formations to be seen as adjacently, such for example comprising a combination of cells arranged both on different columns and on different rows, but at least sharing a side of a cell to another cell holding a matching element. Other definitions of clusters comprising matching elements are of course possible and within the scope of the present disclosure. Such a further example of a cluster may be where matching elements form specific “shapes”, but not necessarily share a cell side with each other. Thus, two adjacent cells may possibly, in some embodiments, be seen as two cells at least having “touching” cell corners.

It should be understood that the shape of the cluster possibly may influence the gaming outcome. As an example, in some embodiments in comparison more “complex” clusters comprising specifically “unusual” elements may generate a different gaming outcome as compared to a less complex cluster comprising “common” elements.

Even though an example is given above as to a cluster comprising matching elements are located adjacently to each other, it should be understood that the gaming outcome generally, and as suggested above, also may be determined just by the fact that the table comprises at least the predetermined number of matching elements.

In a preferred embodiment of the present disclosure, a “new” multiplication factor is assigned for each game in a series of consecutive games provided by the server. However, the multiplication factor could potentially remain assigned to at least one column or row of the table for a set number of games in the series of consecutive games. In such an embodiment it could be possible to allow the multiplication factor to e.g. increase or decrease in integer steps from one game to the next game in the series of consecutive games. For example, the multiplication factor can have a predefined range, such as between one and 10, preferably one and five and more preferably one and three.

Accordingly, in an implementation of the present disclosure a multiplication factor of one (1) is general assigned to each of the rows and the columns of the table, where at least one column or row of the table however has been assigned with a multiplication factor that is above one, such as more than one and no more than ten, or more than one and no more than five, or more than one and no more than three.

It may also within the scope of the present disclosure be possible to assign a multiplication factor to more than one column or more than one row in the table. The multiplication factor may in such an embodiment be the same for the more than one column or more than one row in the table. However, it may also be possible to assign individually valued multiplication factors to different columns or rows of the table.

In a preferred embodiment of the present disclosure the gaming outcome is further determined by i) multiplying, for each column and at the server, a sum of the number of matching elements with the multiplication factor assigned to the column, and ii) multiplying, at the server, a result of the multiplications i) for each column, with each other. For example, in case a column holds two (2) matching elements, the number two will be multiplied with the multiplication factor assigned to that column. If the multiplication factor for that column is two (2), then the result of the multiplication is four (4). The same process is performed by each of the columns in the table, and the result from the multiplication in each of the columns are then multiplied with each other. The result of the multiplication will in turn influence the overall gaming outcome for the specific game.

In another embodiment the gaming outcome is further determined by i) multiplying, for each row and at the server, a sum of the number of matching elements with the multiplication factor assigned to the row, and ii) multiplying, at the server, a result of the multiplications i) for each row, with each other. This embodiment relating to the rows is functioning in the same manner as in regards to the above discussed embodiment relating to the columns.

In another embodiment the gaming outcome is further determined by i) multiplying each matching element in the row with the multiplication factor assigned to the row, and multiplying, at the server, a result of the multiplications i) for each column with each other. This embodiment relating will also function in a corresponding manner as was discussed above, but allows for a combination of both the rows and the columns for determining the gaming outcome. It should of course be understood that further possibilities exists within the scope of the present disclosure with combining one or multiple multiplication factors, rows and columns for determining the gaming outcome.

In some embodiments it may be possible to further increase the randomness (and thus also the security) of the game by introducing a generic type element, in some embodiments defined as a wild card or a joker element, where the generic type element may be matchable to all of the plurality of predefined element types. As such, the generic element type may be equally matchable with e.g. a number as well as a symbol. The generic element may as such form further, more complicated clusters or be included when determining the number of matching elements within the table. The introduction of the generic type element may possibly generate an increased payout to the player, increase the attractiveness of the game, promote the player to continue playing the game, while at the same time balancing the risk for the operator of the gaming system.

Preferably, one or a plurality of generic type elements are comprised with the set of elements corresponding to the plurality of cells, as generated by the server. Accordingly, new generic elements are potentially generated for each set of elements generated for each of the game in the series of consecutive games. It may however be possible, and within the scope of the present disclosure, to allow also the generic type element(s) to have a predetermined lifetime, meaning that the generic type element(s) potentially could remain within the same cell for a predefined number of consecutive games. Such embodiments may even further allow for operator controllability of the gaming system, while also possibly increasing the payout for the player.

In some embodiment of the present disclosure it may be possible to adapt the gaming system to operate a main game and a bonus game, where the generic type element is only formed during a bonus game. Accordingly, the operator of the gaming system may be provided with even further control of when and where the generic type element is to be introduced. This also allow the operator to in a swift way control how to “drive” players to play specific (main) games, where the main games are provided with thereto related bonus game. The bonus games may for example include a free spin, a respin or both (when the game relates to a slot game).

In some embodiments of the present disclosure the series of consecutive games are games of chance, such as for example including a slot game, where the player is placing a bet to be allowed to participate in the game (or series of games). The gaming outcome may in such an embodiment be dependent on the bet placed by the player.

The concept according to the present disclosure may however be applied to other types of games, including e.g. sports bet or similar, where the gaming outcome generated by means of the present scheme may be used for e.g. allowing the player to increase a total outcome generated by e.g. a sports bet.

As indicated above, the server is in charge of controlling the electronic user device to display the table as well as the gaming outcome at the display screen of the electronic user device. In some embodiments the electronic user device is adapted to present a graphical user interface (GUI) at the display screen. The server may in a corresponding manner be adapted to a graphical representation of at least one of the table or the gaming outcome, to be distributed to the electronic user device, where the graphical representation is then presented within the GUI.

Such a GUI may also be arranged to allow the player to directly interact with the server, for example allowing the player to control his/her participation in the game as well as to control a size of the bet placed when participating in the game.

Within the context of the present disclosure the expression “forming a graphical representation” should be interpreted broadly. Specifically, it should be understood that the server in some embodiments may be configured to only form a collection of “meta-data” (here corresponding to the graphical representation) that will be rendered at the frontend, such as within the GUI of the electronic user device. However, in another embodiment it may be the other way around, meaning that the server will essentially form an image (here corresponding to the graphical representation) that then will be displayed within the GUI of the electronic user device. Further alternative implementations along the same mutations are possible and within the scope of the present disclosure. Additionally, it may also be possible to allow the graphical representation to be set differently for different game operators, players or groups of players. The graphical representation may also be dependent on e.g. the geographical location of the players, such as dependent on city, country or continent where the player is located/registered.

Within the context of the present disclosure it should be understood that in some embodiments it may be possible to allow the server to control if a specific electronic user device is to be allowed to apply the scheme according to the present disclosure. Such control may for example be dependent on a geographical location of the electronic user device. Possibly, the geographical location may be selected from a group comprising a city, a country and a continent.

According to another aspect of the present disclosure there is provided a gaming system comprising a server arranged in communication with an electronic user device using a network connection, the electronic user device comprising a display screen, wherein the server is adapted to form, at the server, a table having a predefined dimension with columns and rows and comprising a plurality of cells, generate, at the server, a set of elements corresponding to the plurality of cells, each generated element being one of a plurality of predefined element types, populate, at the server, the plurality of cells with the set of elements, direct, using the server, the electronic user device to display the table at the display screen, assign, at the server, a multiplication factor to at least one column or row of the table, identify, at the server and by applying a predefined identification scheme, a number of cells of the table being populated with matching elements, determine, at the server, a gaming outcome based on the number and location of the matching elements within the table and the multiplication factor assigned to the at least one column or row of the table, and direct, using the server, the electronic user device to display the gaming outcome at the display screen. This aspect of the present disclosure provides similar advantages and embodiments as discussed above in relation to the previous aspects of the present disclosure.

Preferably, the gaming system is a cloud-based computing system and the server is a cloud server. Thus, the computing power provided by means of the invention may be distributed between a plurality of servers, and the location of the servers must not be explicitly defined. Advantageous following the use of a cloud-based solution is also the inherent redundancy achieved.

In some embodiments the electronic user devices may be selected to include e.g. a computer (laptop/stationary), a mobile phone, a tablet, a (gaming) consoles or any other gaming device and gambling terminals. The GUI may in some embodiments be allowed to depend on the type of electronic user device.

According to a still further aspect of the present disclosure there is provided a computer program product comprising a computer readable medium having stored thereon computer program means for operating a gaming system, the gaming system comprising a server arranged in communication with an electronic user device using a network connection, the electronic user device comprising a display screen, wherein the computer program product comprises code for forming, at the server, a table having a predefined dimension with columns and rows and comprising a plurality of cells, code for generating, at the server, a set of elements corresponding to the plurality of cells, each generated element being one of a plurality of predefined element types, code for populating, at the server, the plurality of cells with the set of elements, code for directing, using the server, the electronic user device to display the table at the display screen, code for assigning, at the server, a multiplication factor to at least one column or row of the table, code for identifying, at the server and by applying a predefined identification scheme, a number of cells of the table being populated with matching elements, code for determining, at the server, a gaming outcome based on the number and location of the matching elements within the table and the multiplication factor assigned to the at least one column or row of the table, and code for directing, using the server, the electronic user device to display the gaming outcome at the display screen. Also this aspect of the present disclosure provides similar advantages and embodiments as discussed above in relation to the previous aspects of the present disclosure.

The computer program product is typically executed using a computing device comprised with the server, preferably including a microprocessor or any other type of computing device. Similarly, a software executed by the server for operating the gaming system may be stored on a computer readable medium, being any type of memory device, including one of a removable nonvolatile random access memory, a hard disk drive, a floppy disk, a CD-ROM, a DVD-ROM, a USB memory, an SD memory card, or a similar computer readable medium known in the art. Accordingly, operation of the gaming system may be at least partly automated, implemented as e.g. software, hardware and a combination thereof.

Further features of, and advantages with, the present disclosure will become apparent when studying the appended claims and the following description. The skilled addressee should realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates an exemplary gaming system according to a currently preferred embodiment of the present disclosure,

FIG. 2 provides an exemplary illustration of a typical graphical user interface (GUI) for use in playing a game,

FIGS. 3A and 3B present exemplary illustrations of operations of different tables according to different embodiments of the present disclosure, and

FIG. 4 is a flow chart illustrating the exemplary steps for operating the gaming system as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness to fully convey the scope of the present disclosure to the skilled addressee. Like reference characters refer to like elements throughout.

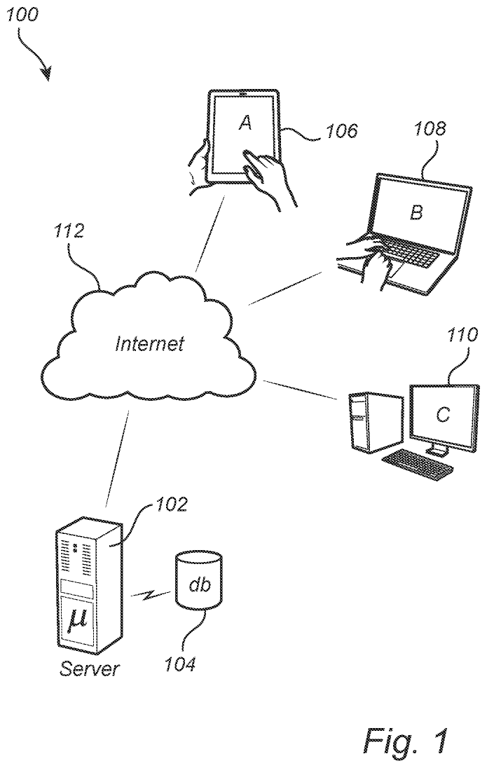

Referring now to the drawings and FIG. 1 in particular, there is depicted a gaming system 100 in which an online game, such as a slot game, may be played according to a currently preferred embodiment of the present disclosure. The system architecture illustrated in FIG. 1 depicts a system environment in which systems, methods, apparatus, computer-readable mediums and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one server 102 and/or at least one gaming database 104. Server 102 and gaming database 104 may be communicably linked to a plurality of electronic user devices in the form of electronic user devices, such as client devices 106, 108, 110, etc. through network 112. The network 112 may be wired or wireless, including for example wired connections like a building LAN, a WAN, an Ethernet network, an IP network, etc., and wireless connections like WLAN, CDMA, GSM, GPRS, 3G mobile communications, 4G mobile communications, Bluetooth, infrared, or similar. As such, the network 112 may be locally and/or globally provided.

The gaming database 104 may be any type of physical unit on which games reside, such as a machine in a gaming venue, a lottery machine, an electronic game system, etc. Network 112 may be implemented as the Internet, or any local or wide area network, either public or private. Network 112 may also be a hardware system physically connecting some or all of the server 102 and client devices 106, 108, 110. Client devices 106, 108, 110, typically each operated by a player, may be implemented as any computing devices such as a personal computing device, a server, a server network, handheld computing device, slot machine, other gaming machine in a gaming venue such as a betting terminal, a gaming console, lottery machine, an interface in a virtual environment, etc.

It may be appreciated by one of ordinary skill in the art that while only one server, one gaming database, one network and two client devices are depicted, more or fewer servers, more or fewer gaming databases, more networks and more or fewer client devices and/or other devices may reside within system 100.

The elements inside system 100 may include one or more (micro) processors, purpose-built hardware such as, for example, FPGA, ASIC, etc., software systems and applications, software packages, mechanical and electrical parts, etc. Software packages that may be part of server 102, gaming database 104, client devices 106, 108, 110 and network 112 may be recorded on a computer readable medium such as a memory device, RAM, CD/DVD/USB drives, handheld memory device, etc., and/or may be part of a physical device such as one or more (microprocessors or electro-mechanical systems. Any of server 102, gaming database 104, client devices 106, 108, 110, network 112 and further electronic user device 114 may be fixed systems, mobile systems, portable systems, or cloud systems (as discussed above). FIG. 1 shows only three electronic user devices 106, 108, 110, however it should be understood that a general implementation of the present disclosure comprises a large plurality of electronic user devices, possibly greatly above three, such as 100, 1000, 10000, etc.

Although the various components of FIG. 1 are illustrated as discrete elements, it should be recognized that certain operations of some of the various components may be performed by the same physical device, e.g., by one or more microprocessors or other type of devices.

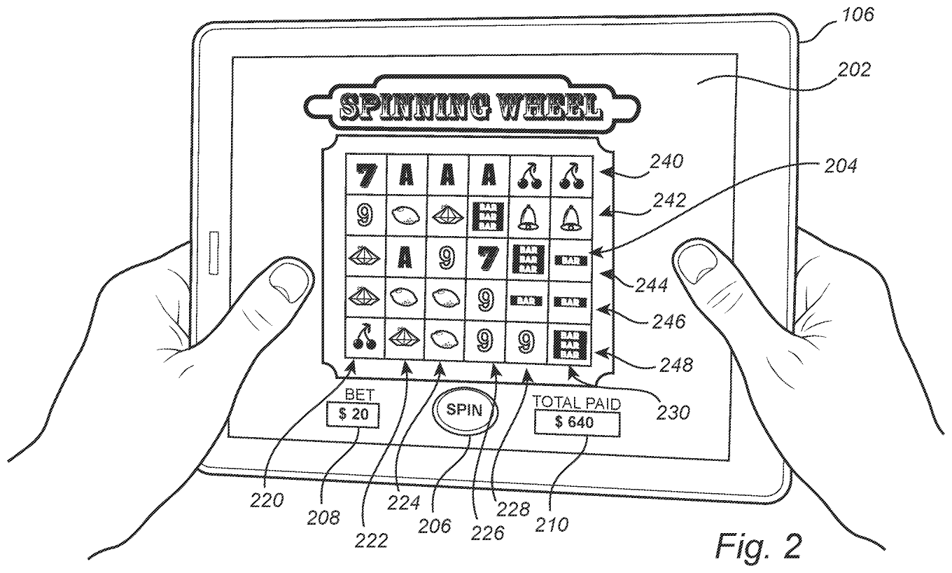

Turning now to FIG. 2 illustrating a graphical user interface (GUI) 202 to be displayed at a client device, such as any of the client devices 106, 108, 110, in the illustrated embodiment provided as an application (“app”) or within e.g. a web browser of the portable client device 106 being a tablet. The game to be played at the client device 106 is here shown as an online game of chance in the form of a slot game, visualized within the GUI 202 as comprising a table comprising six individual reels 220, 222, 224, 226, 228, 230 arranged in columns and provided with a plurality of different symbols. The table also comprises five rows 240, 242, 244, 246, 248. As such, the predefined dimension of the table as shown in FIG. 2 is six times five, thus comprising 30 cells in total.

The GUI also comprises a “button” 206 to start the game, here provided with the description “SPIN” for initiating a turn of the game. In addition, the GUI 202 comprises an indicator of the current bet 208 (i.e. payment for each turn of the game) and an indicator of the total payment to the player 210. It should in any case be understood that other types of games may be played within the scope of the present disclosure, for example being skill based as compared to a game of chance.

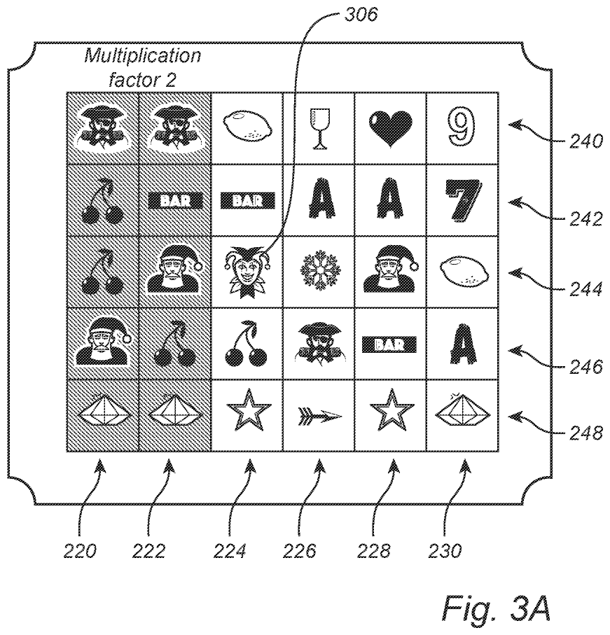

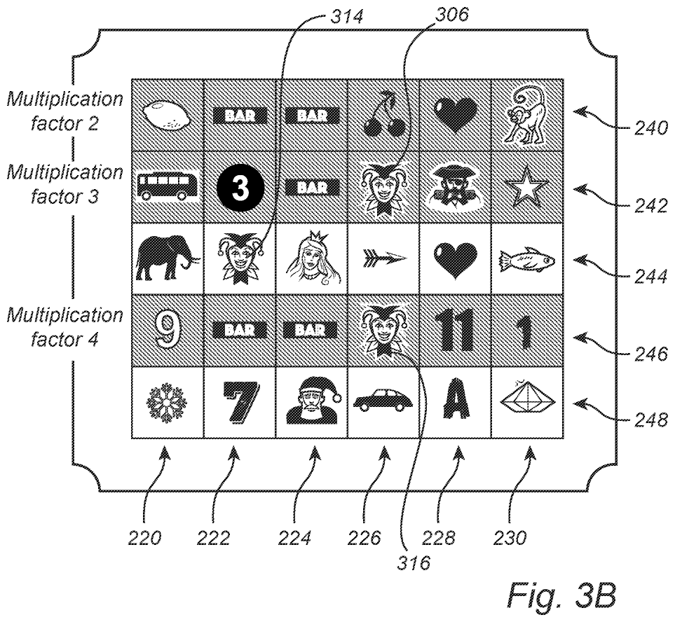

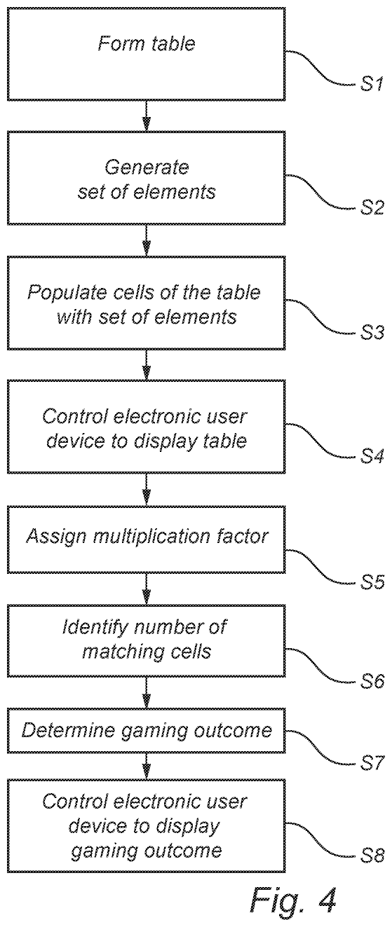

Turning now to FIGS. 3A and 3B in conjunction with FIG. 4, illustrating different tables according to different embodiments of the present disclosure. In FIG. 3A there is first shown an initial table 300 comprising a plurality of cells 302 arranged in rows and columns, corresponding to the table as shown in FIG. 2, e.g. displayable at a display screen of any of the client devices 106, 108, 110.

As is exemplified in FIG. 3A, the server 102 has formed, S1, and then generated, S2, a first set of elements which have been arranged to populate, S3, the initial table 300. The server has then controlled, S4, the client device 106, for example, to display the populate table 300. In the case of a game of chance the elements may be at least semi-randomly generated and similarly the positioning of the elements within the table 300 may be semi-randomly selected. The set of elements comprises a plurality of predefined elements types, in FIG. 3A, a cherry 304, a diamond, the number seven, a heart etc. and a first generic type element 306. The generic type element may in some embodiments be defined as a ‘wild card’ or a ‘joker’ element.

The server 102 has furthermore assigned, S5, a first multiplication factor being above one (1) to the left most column 220 and a second multiplication being above one (1) to the second left most column 222. In this embodiment the first multiplication factor is the same as the second multiplication factor, where the first and the second multiplication factor is two. The further columns 224, 226, 228, 230 have not been assigned a multiplication factor above one (1), but for these columns the multiplication factor may be seen as one or ignored in the determination of the gaming outcome. In the example presented in FIG. 3A no specific multiplication factor being more than one (1) has been assigned to the rows 240, 242, 244, 246, 248.

It may in accordance to the present disclosure be advantageous to highlight the location of the multiplication factors. In FIG. 3A this is shown by a “shading” of left most column 220 and to the second left most column 222.

In the server 102 will then identify, S6, a number of cells of the table being populated with matching elements. In the example as presented in FIG. 3A, it is necessary that the table 300 comprises at least five matching elements. In FIG. 3A, the table 300 comprises four “cherries” 304, i.e. matching elements, plus a generic joker element 306, totaling five matching elements and thus being above the threshold of five matching elements. The determination, S7, of the gaming outcome may then be proceeded.

In FIG. 3A the determination of the gaming outcome is performed by the server 102 by multiplying, for each column, a sum of the number of matching elements with the multiplication factor assigned to the column, and then ii) multiplying a result of the multiplications i) for each column, with each other.

As exemplified in FIG. 3A the column 220 comprises two cherries 304 and has been assigned the first multiplication factor of two. The result of the multiplication for the column 220 is thus two by two equals four.

The column 222 comprises one cherry 304 and has been assigned the second multiplication factor of two. The result of the multiplication for the column 222 is thus one by two equals two.

The column 224 comprises one cherry 304 and the joker element 306 (equals 2), and has not been assigned a multiplication factor (also defined as a multiplication factor of one (1)). The result of the multiplication for the column 224 is thus two by one equals two.

The column 226 comprises zero cherry 304 and has not been assigned a multiplication factor (also defined as a multiplication factor of one (1)). The result of the multiplication for the column 226 is thus zero by zero, meaning that the result from this column is non-applicable.

The column 228 comprises zero cherry 304 and has not been assigned a multiplication factor (also defined as a multiplication factor of one (1)). The result of the multiplication for the column 228 is thus zero by zero, meaning that the result from this column is non-applicable.

The column 230 comprises zero cherry 304 and has not been assigned a multiplication factor (also defined as a multiplication factor of one (1)). The result of the multiplication for the column 230 is thus zero by zero, meaning that the result from this column is non-applicable.

The server 102 then multiplies the result for each column 220, 222, 224, 226, 228, 230. In the present example (excluding columns 226, 228 and 230 since the result is non-applicable) the overall result will be four times two times two (4×2×2), equals 16.

The gaming outcome will thus in this preferred embodiment be influenced by the resulting number 16. Possibly, the bet placed by the player may be multiplied by 16, meaning that a payout to the player may be 16 times the bet placed by the player.

In accordance to the present disclosure, once the gaming output has been determined, the server 102 will control the electronic user device 106 to display the gaming outcome at the display screen.

In FIG. 3B, a second consecutive table 310 of the game (in the series of games) is shown where the table 310 has been populated by the server 102 with a further set of elements. The second set of elements comprises a plurality of predefined elements types as in FIG. 3A, the first joker 306, a second joker 314 and a third joker 316. Here five elements of the “bars” type 320 “occupies” six different cells of the table 310.

In the embodiment as illustrated in FIG. 3B, a first multiplication factor has been assigned to the row 240, a second multiplication factor has been assigned to the row 242 and a third multiplication factor has been assigned to the row 246. The first, the second and the third multiplication factor is two, three and four, respectively. The remaining rows 244 and 248 have not been assigned a multiplication factor above one (1), but for these columns the multiplication factor may be seen as one or ignored in the determination of the gaming outcome. In the example presented in FIG. 3B, no specific multiplication factor being more than one (1) has been assigned to the columns 220, 222, 224, 226, 228, 230.

The rows assigned with multiplication factors above one (1) has in a manner corresponding to FIG. 3A been highlighted, here shown as a shading.

The determination of the gaming outcome follows the same structure as in relation to FIG. 3A, as exemplified below.

Row 240: two (2) bars 320 multiplied by the first multiplication factor (2)=four (4).

Row 242: one (1) bar 320 and the first joker 306 (equals 2) multiplied by the second multiplication factor (3)=six (6).

Row 244: zero bar 320 and the second joker 314 (equals 1), with no multiplication factor=1=non-applicable.

Row 246: two (2) bar 320 and the third joker 316 (equals 3) multiplied by the third multiplication factor (4)=twelve (12).

Row 248: zero bar 320 and no multiplication factor=1=non-applicable.

The server 102 then multiplies the result for each row 240, 242, 244, 246, 248. In the present example (excluding rows 244 and 248 since the result is non-applicable) the overall result will be four times six times twelve, equals 1008. The gaming outcome will thus be influenced by the resulting number 1008.

A further, non-explicitly illustrated, embodiment of the present disclosure may involve a combination of the embodiments above. FIG. 3B can be used to illustrate this embodiment too. As above, a first multiplication factor has been assigned to the row 240, a second multiplication factor has been assigned to the row 242 and a third multiplication factor has been assigned to the row 246. The first, the second and the third multiplication factor is two, three and four, respectively. The remaining rows 244 and 248 have not been assigned a multiplication factor above one (1), but for these columns the multiplication factor may be seen as one or ignored in the determination of the gaming outcome. As in regards to the example presented in FIG. 3B, no specific multiplication factor being more than one (1) has been assigned to the columns 220, 222, 224, 226, 228, 230.

The determination of the gaming outcome follows a combination of the structure as in relation to FIGS. 3A and 3B, as exemplified below.

Row 240: two (2) bars 320, in columns 222 and 224 each bar multiplied by the first multiplication factor (2)=two (2) each.

Row 242: one (1) bar 320 and the first joker 306 (equals 2) each to be multiplied by the second multiplication factor (3)=three (3) each.

Row 244: zero bar 320 and the second joker 314 (equals 1), with no multiplication factor=1=non-applicable.

Row 246: two (2) bar 320 and the third joker 316 each multiplied by the third multiplication factor (4)=four (4) each.

Row 248: zero bar 320 and no multiplication factor=1=non-applicable.

The server 102 then multiplies the result for each column 220, 222, 224, 226, 228, 230. In the present example (excluding rows 244 and 248 since the result is non-applicable) the overall result will be two times four for column 222 which equals 8, two times three times four for column 224 which equals 24 for column 224 and three times four which equals 12 for column 226. The gaming outcome will thus be influenced by the resulting number 2304.

It should be understood that the examples above are just for provided for explaining the general concept of the present disclosure. Accordingly, the examples are in no way limiting to the general scope of the present disclosure.

In summary, the present disclosure relates to a computer implemented method performed by a gaming system, the gaming system comprising a server arranged in communication with an electronic user device using a network connection, the electronic user device comprising a display screen, wherein the method comprises the steps of forming, at the server, a table having a predefined dimension with columns and rows and comprising a plurality of cells, generating, at the server, a set of elements corresponding to the plurality of cells, each generated element being one of a plurality of predefined element types, populating, at the server, the plurality of cells with the set of elements, controlling, using the server, the electronic user device to display the table at the display screen, assigning, at the server, a multiplication factor to at least one column or row of the table, identifying, at the server, a number of cells of the table being populated with matching elements, determining, at the server, a gaming outcome based on the number and location of the matching elements within the table and the multiplication factor assigned to the at least one column or row of the table, and controlling, using the server, the electronic user device to display the gaming outcome at the display screen.

An advantage following such a possibility is an improved attraction power to the game, thus potentially allowing for the player to remain playing the game for an increased duration as compared to previously known similar operational schemes. This could potentially be beneficial to both the player participating in the game and the gaming operator providing the game.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

1. A computer implemented method performed by a gaming system, the gaming system comprising a server arranged in communication with an electronic user device using a network connection, the electronic user device comprising a display screen, wherein the method comprises the steps of:
forming, at the server, a table having a predefined dimension with columns and rows and comprising a plurality of cells,
generating, at the server, a set of elements corresponding to the plurality of cells, each generated element being one of a plurality of predefined element types,
populating, at the server, the plurality of cells with the set of elements,
directing, using the server, the electronic user device to display the table at the display screen,
assigning, at the server, a multiplication factor to at least one column or row of the table,
identifying, at the server and by applying a predefined identification scheme, a number of cells of the table being populated with matching elements,
determining, at the server, a gaming outcome based on the number and location of the matching elements within the table and the multiplication factor assigned to the at least one column or row of the table, and
directing, using the server, the electronic user device to display the gaming outcome at the display screen.

2. The method according to claim 1, wherein the gaming outcome is further determined by:
i) multiplying, for each column and at the server, a sum of the number of matching elements with the multiplication factor assigned to the column, and
ii) multiplying, at the server, a result of the multiplications i) for each column, with each other.

3. The method according to claim 1, wherein the gaming outcome is further determined by:
i) multiplying each for each row at the server, a sum of the number of matching elements with the multiplication factor assigned to the row, and
ii) multiplying, at the server, a result of the multiplications i) for each row, with each other.

4. The method according to claim 1, wherein the gaming outcome is further determined by:
i) multiplying each matching element in the row with the multiplication factor assigned to the row, and
ii) multiplying, at the server, a result of the multiplications i) for each column with each other.

5. The method according to claim 1, wherein the number of cells of the table being populated with matching elements comprises a generic type element matchable to each of the plurality of predefined element types.

6. The method according to claim 1, wherein a multiplication factor is assigned to more than one column or more than one row in the table.

7. The method according to claim 1, wherein the multiplication factor has a predefined range.

8. The method according to claim 1, further comprising the step of:
receiving, at the server, a bet from the electronic device,
wherein the determination of the gaming outcome is further dependent on the bet.

9. The method according to claim 1, wherein the electronic user device is adapted to present a graphical user interface (GUI) at the display unit, and the method further comprises the steps of:
forming, at the server, a graphical representation of at least one of the table of the gaming outcome, and
distributing, from the server to the electronic user device, the graphical representation.

10. A gaming system comprising a server arranged in communication with an electronic user device using a network connection, the electronic user device comprising a display screen, wherein the server is adapted to:
form, at the server, a table having a predefined dimension with columns and rows and comprising a plurality of cells,
generate, at the server, a set of elements corresponding to the plurality of cells, each generated element being one of a plurality of predefined element types,
populate, at the server, the plurality of cells with the set of elements,
direct, using the server, the electronic user device to display the table at the display screen,
assign, at the server, a multiplication factor to at least one column or row of the table,
identify, at the server and by applying a predefined identification scheme, a number of cells of the table being populated with matching elements,
determine, at the server, a gaming outcome based on the number and location of the matching elements within the table and the multiplication factor assigned to the at least one column or row of the table, and
direct, using the server, the electronic user device to display the gaming outcome at the display screen.

11. The gaming system according to claim 10, wherein the server is further adapted to determine the gaming outcome by:
i) multiply, for each column and at the server, a sum of the number of matching elements with the multiplication factor assigned to the column, and
ii) multiply, at the server, a result of the multiplications i) for each column, with each other.

12. The gaming system according to claim 10, wherein the server is further adapted to determine the gaming outcome by:
i) multiply, for each row, a sum of the number of matching elements with the multiplication factor assigned to the row, and
ii) multiply a result of the multiplications i) for each row, with each other.

13. The gaming system according to claim 10, wherein the server is further adapted to determine the gaming outcome by:
i) multiplying each matching element in the row with the multiplication factor assigned to the row, and
ii) multiplying, at the server, a result of the multiplications i) for each column with each other.

14. The gaming system according claim 10, wherein the number of cells of the table being populated with matching elements comprises a generic type element matchable to each of the plurality of predefined element types.

15. The gaming system according to claim 10, wherein a multiplication factor is assigned to more than one column or more than one row in the table.

16. The gaming system according to claim 10, wherein the multiplication factor has a predefined range.

17. The gaming system of claim 16, wherein the range is between 1 and 10.

18. The gaming system according to claim 10, wherein the server is further adapted to:
receive a bet from the electronic user device,
wherein the determination of the gaming outcome is further dependent on the bet.

19. The gaming system according to claim 10, wherein the electronic user device is adapted to present a graphical user interface (GUI) at the display screen, and the server is further adapted to:
form a graphical representation of at least one of the table or the gaming outcome, and
distribute the graphical representation to the electronic user device.

20. A computer program product comprising a computer readable medium having stored thereon computer program means for operating a gaming system, the gaming system comprising a server arranged in communication with an electronic user device using a network connection, the electronic user device comprising a display screen, wherein the computer program product comprises:
code for forming, at the server, a table having a predefined dimension with columns and rows and comprising a plurality of cells,
code for generating, at the server, a set of elements corresponding to the plurality of cells, each generated element being one of a plurality of predefined element types,
code for populating, at the server, the plurality of cells with the set of elements,
code for directing, using the server, the electronic user device to display the table at the display screen,
code for assigning, at the server, a multiplication factor to at least one column or row of the table,
code for identifying, at the server and by applying a predefined identification scheme, a number of cells of the table being populated with matching elements,
code for determining, at the server, a gaming outcome based on the number and location of the matching elements within the table and the multiplication factor assigned to the at least one column or row of the table, and
code for directing, using the server, the electronic user device to display the gaming outcome at the display screen.
